(19) United States
(12) Patent Application Publication
(10) Pub. No.: US 2017/0061346 A1
(43) Pub. Date: Mar. 2, 2017

(54) CORRELATING DATA FROM SATELLITE IMAGES WITH RETAIL LOCATION PERFORMANCE

(71) Applicant: Wal-Mart Stores, Inc., Bentonville, AR (US)

(72) Inventors: Donald High, Noel, MO (US); Alan Lee Jamison, Fayetteview, AR (US); Michael Dean Atchley, Springdale, AR (US)

(21) Appl. No.: 15/248,691

(22) Filed: Aug. 26, 2016

Related U.S. Application Data
(60) Provisional application No. 62/211,598, filed on Aug. 28, 2015.

(51) Int. Cl. G06Q 10/06; G06K 9/62; G06K 9/00

(52) U.S. Cl. CPC G06Q 10/0639; G06K 9/00637; G06K 9/6201

(57) ABSTRACT

The present invention extends to methods, systems, and computer program products for correlating data from satellite images with retail location performance. A computer system accesses extracted satellite image data that has been extracted from satellite imagery of a retail location. The computer system also accesses one or more other types of data related to the retail location, such as, for example, retail location performance data and data pertaining to community events within the retail location community. The computer system performs a statistical analysis to determine the correlation between the satellite image data and one or more of the community events and the retail location performance. The computer system generates a visualization of the analyzed data for presentation at a display device to assist with making operations related decisions for the retail location. In some aspects, the satellite imagery is overlaid on the visualization of the analyzed data.

### CROSS-REFERENCE TO RELATED APPLICATIONS

This application claims the benefit of U.S. Provisional Patent Application 62/211,598, filed Aug. 28, 2015, and titled “Correlating Data From Satellite Images With Retail Location Performance”, the entire contents of which are hereby incorporated herein by reference

### BACKGROUND

1. Field of the Invention

This invention relates generally to retail store performance, and, more particularly, to correlating data from satellite images with retail store performance.

2. Related Art

Retail stores are in the business of selling consumer goods and/or services to customers through multiple channels of distribution. Performance of a retail store can be measured across many factors, including, but are not limited to, (1) cost incurred by the retail store, including direct and indirect cost, (2) markup, which is the amount a seller can charge on top of the actual cost of delivering a product to market in order to make a profit, (3) inventory and distribution, and (4) sales and service strategies. In order to improve performance, retail stores often collect data to understand these factors, and identify areas for improvement.

Given these factors and the large number of parameters that can affect store performance, it can be difficult to understand and identify the areas needing improvement. Analytics can be used to evaluate the large volume of data that impacts store performance and focus efforts on those areas that provide the largest return on investment. Analytics includes the discovery and communication of meaningful patterns in data. Especially valuable in areas rich with recorded information, analytics relies on the simultaneous application of statistics, computer programming, and operations research to quantify performance. Analytics often favors data visualization to communicate insight.

Retail store analytics typically comes directly from the retail environment. The data can include such information as point-of-sale (POS) performance, types of items sold, numbers of items sold, numbers of sale items sold, number of workers, losses due to theft, etc. This data can be evaluated against store performance to determine what factors have the greatest impact on store profitability and customer satisfaction.

However, relying heavily on POS data or other data directly collected from a retail store may not fully characterize store performance. Other factors associated with a community or surrounding area can also impact store performance. For example, a sporting or entertainment event in the area of a retail store can impact performance. Physical conditions around a retail store, such as, parking availability outside of the store parking lot, nearby traffic control signals, weather, etc., can also impact store performance.

### BRIEF DESCRIPTION OF THE DRAWINGS

The specific features, aspects and advantages of the present invention will become better understood with regard to the following description and accompanying drawings where:

FIG. 1 illustrates an example block diagram of a computing device.

FIG. 2 illustrates an example computer architecture that facilitates correlating data from satellite images with retail location performance.

FIG. 3 illustrates a flow chart of an example method for correlating data from satellite images with retail location performance.

### DETAILED DESCRIPTION

The present invention extends to methods, systems, and computer program products for correlating data from satellite images with retail location performance.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. RAM can also include solid state drives (SSDs or PCIx based real time memory tiered Storage, such as FusionIO). Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the invention can also be implemented in cloud computing environments. In this description and the following claims, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (SaaS), Platform as a Service (PaaS), Infrastructure as a Service (IaaS), and deployment models (e.g., private cloud, community cloud, public cloud, hybrid cloud, etc.). Databases and servers described with respect to the present invention can be included in a cloud model.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the following description and Claims to refer to particular system components. As one skilled in the art will appreciate, components may be referred to by different names. This document does not intend to distinguish between components that differ in name, but not function.

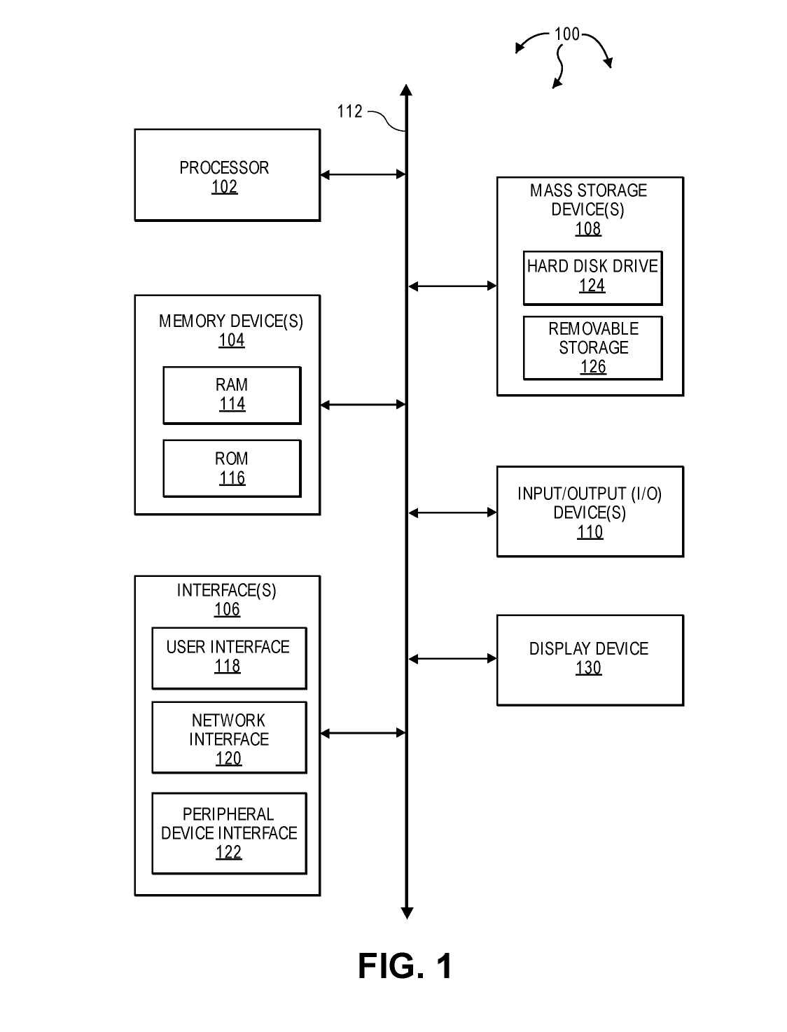

FIG. 1 illustrates an example block diagram of a computing device 100. Computing device 100 can be used to perform various procedures, such as those discussed herein. Computing device 100 can function as a server, a client, or any other computing entity. Computing device 100 can perform various communication and data transfer functions as described herein and can execute one or more application programs, such as the application programs described herein. Computing device 100 can be any of a wide variety of computing devices, such as a mobile telephone or other mobile device, a desktop computer, a notebook computer, a server computer, a handheld computer, tablet computer and the like.

Computing device 100 includes one or more processor(s) 102, one or more memory device(s) 104, one or more interface(s) 106, one or more mass storage device(s) 108, one or more Input/Output (I/O) device(s) 110, and a display device 130 all of which are coupled to a bus 112. Processor(s) 102 include one or more processors or controllers that execute instructions stored in memory device(s) 104 and/or mass storage device(s) 108. Processor(s) 102 may also include various types of computer storage media, such as cache memory.

Memory device(s) 104 include various computer storage media, such as volatile memory (e.g., random access memory (RAM) 114) and/or nonvolatile memory (e.g., read-only memory (ROM) 116). Memory device(s) 104 may also include rewritable ROM, such as Flash memory.

Mass storage device(s) 108 include various computer storage media, such as magnetic tapes, magnetic disks, optical disks, solid state memory (e.g., Flash memory), and so forth. As depicted in FIG. 1, a particular mass storage device is a hard disk drive 124. Various drives may also be included in mass storage device(s) 108 to enable reading from and/or writing to the various computer readable media. Mass storage device(s) 108 include removable media 126 and/or non-removable media.

I/O device(s) 110 include various devices that allow data and/or other information to be input to or retrieved from computing device 100. Example I/O device(s) 110 include cursor control devices, keyboards, keypads, barcode scanners, microphones, monitors or other display devices, speakers, printers, network interface cards, modems, cameras, lenses, CCDs or other image capture devices, and the like.

Display device 130 includes any type of device capable of displaying information to one or more users of computing device 100. Examples of display device 130 include a monitor, display terminal, video projection device, and the like.

Interface(s) 106 include various interfaces that allow computing device 100 to interact with other systems, devices, or computing environments as well as humans. Example interface(s) 106 can include any number of different network interfaces 120, such as interfaces to personal area networks (PANs), local area networks (LANs), wide area networks (WANs), wireless networks (e.g., near field communication (NFC), Bluetooth, Wi-Fi, etc, networks), and the Internet. Other interfaces include user interface 118 and peripheral device interface 122.

Bus 112 allows processor(s) 102, memory device(s) 104, interface(s) 106, mass storage device(s) 108, and I/O device(s) 110 to communicate with one another, as well as other devices or components coupled to bus 112. Bus 112 represents one or more of several types of bus structures, such as a system bus, PCI bus, IEEE 1394 bus, USB bus, and so forth.

In general, aspects of the invention are used to monitor stores, shopping clubs, and surrounding areas to create a better customer experience by evaluating outside influence and area conditions. Aspects combine data extracted form satellite images with other data, including but not limited to Point-Of-Sale data, competitor data, weather analysis data, traffic/visit analysis data, situational damage, patio sales, garden center activity, news data, sporting even data, local activity information, customer satisfaction data, and human resources. Satellite images can be analyzed and data extracted therefrom. The extracted satellite data can be matched up with the other data to gain a better understanding of what is happening around a store. For example, extracted satellite data can reveal a variety of factors related to store performance that might otherwise be difficult to detect, such as, for example, number of cars in a parking lot, store area condition, heavy traffic flow around the area of a store, competitor traffic, population of an area, weather impact, disaster impact, and influence of community events.

In one more particular aspect, satellite image data is correlated with the performance of a retail location. A computer system accesses extracted data that has been extracted from satellite imagery of a retail location (e.g., a store, shopping club, etc.). The extracted data indicates physical conditions around the outside of the retail location out to a specified distance from the retail location. The computer system also accesses one or more other types of data related to the retail location. The one or more other types of data indicate a plurality of other characteristics of the retail location.

The computer system analyzes the physical conditions around the outside of the retail location along with the plurality of other characteristics of the retail location to derive one or more further aspects of the retail location. The one or more further aspects are derived by combining the extracted data and the one or more other types of data in a statistical analysis. The computer system generates a graphical visualization representing the one or more further aspects of the retail location. The computer system matches the graphical visualization to the satellite imagery for presentation at a display device to assist with making an operations decision related to retail location performance based on the one or more further aspects of the retail location.

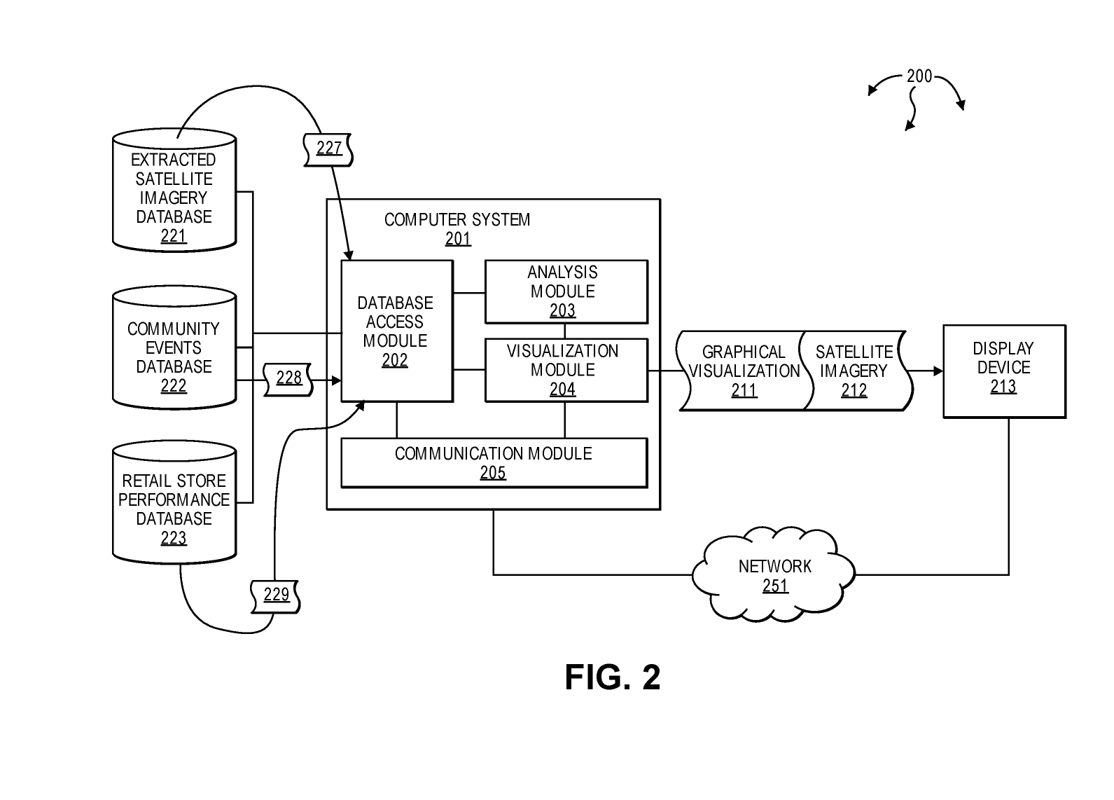

FIG. 2 illustrates an example computer architecture 200 that facilitates correlating data from satellite images with retail location performance. Referring to FIG. 2, computer architecture 200 includes computer system 201, extracted satellite image database 221, community events database 222, retail location performance database 223, and display device 213. Each of computer system 201, extracted satellite image database 221, community events database 222, retail location performance database 223, and display device 213 as well as their respective components can be connected to one another over (or be part of) network 251, such as, for example, a PAN, a LAN, a WAN, and even the Internet. Accordingly, each of computer system 201, extracted satellite image database 221, community events database 222, retail location performance database 223, and display device 213 as well as any other connected computer systems and their components, can create message related data and exchange message related data (e.g., near field communication (NFC) payloads, Bluetooth packets, Internet Protocol (IP) datagrams and other higher layer protocols that utilize IP datagrams, such as, Transmission Control Protocol (TCP), Hypertext Transfer Protocol (HTTP), Simple Mail Transfer Protocol (SMTP), etc.) over network 251.

As depicted, computer system 201 includes database access module 202, analysis module 203, visualization module 204, and communication module 205.

Generally, database access module 202 is configured to access data from any of extracted satellite imagery database 221, community events database 222, and the retail location performance database 223. Database access module 202 can perform database related operations, such as, for example, querying data contained within the databases, sorting data, creating tables, searching for timestamped data within a specified date range, creating custom views, etc.

Extracted satellite imagery database 221 can contain data that was previously extracted from satellite images. Extracted satellite imagery data can include data representative of a retail location and corresponding physical surroundings.

For example, extracted satellite imagery data can represent the area of a retail location parking lot and the percentage of that area being used by parked cars, parked trailers, the garden center, etc. Extracted satellite imagery data can represent traffic conditions near the retail location. The traffic conditions can indicate the accessibility of the retail location from adjacent streets, whether or not a traffic light is located at the entrance to the retail location, the amount of traffic passing the store as compared to the amount of traffic turning into the retail location, etc. Extracted satellite imagery data can represent the amount of foot traffic passing by the retail location, and the percentage of that foot traffic entering the retail location. Extracted satellite imagery data can represent events going on within a retail location's community such as sporting events at a nearby park, social gatherings, holiday events, etc.

Extracted satellite imagery data can also represent physical conditions at competing retail locations, such as parking, accessibility, and street conditions, and the proximity of the competing location to the retail location of interest. Extracted satellite imagery data can represent weather conditions and indicate the percentage of the time the weather conditions are stormy and the percentage of the time the weather conditions are fair.

Extracted satellite imagery data can represent the condition of a retail location through the course of a day, or through the course of a season. For example, the satellite imagery can capture the state of a retail location during the morning hours as compared to the state of the retail location during afternoon hours or evening hours. Extracted satellite imagery data if events affect store attendance such as the arrival of a tractor trailer carrying retail goods, or the effect of road construction at a neighboring street.

In one aspect, extracted satellite imagery database 221 contains time lapse extracted satellite imagery data.

Community events database 222 can contain community events data for a community surrounding a retail location. Community events data can include data for the retail location community such as sporting events data, entertainment data, movie release or concert dates, and local event data such as festivals, art shows, farmer's markets, etc. Community events data can also include data gathered from news outlets or from social media networks. Community events data can also include holiday data and other calendar data, such as dates when school is in session or out of session. Community events data can also include natural disaster data such as forest fire data, earthquake data, tornado data, or flood data.

Retail location performance database can contain retail location performance data. Retail location performance data can include point-of-sale activity, costs incurred by a retail location, inventory details, sales and/or promotions, number of workers, etc.

Analysis module 203 is configured to analyze extracted satellite imagery data (e.g., accessed from extracted satellite imagery database 221) along with data extracted from community events database 222 and retail location performance database 223 to derive aspects of a retail location. Analysis module 203 can perform statistical analysis on data accessed from extracted satellite imagery database 221, community events database 222 and retail location performance database 223, such as correlation analysis, cluster analysis, causal analysis, machine learning, etc. to determine if there are correlations between the various data sets and determine the sensitivities of the correlations. For example, analysis module 203 can analyze the affect that community sporting events has on sporting good and/or sporting apparel sales. Analysis module 203 can analyze the affect that a natural disaster has on emergency preparedness and food sales. Analysis module 203 can also analyze point-of-sale (POS) performance as it relates to parking availability and corresponding weather images.

Visualization module 204 is configured to graphically portray output from analysis module 203. For example, visualization module 204 can generate heat maps, fractal maps, and tree maps, where the maps are visual indications of store performance as it relates to community events and/or satellite images. Visualization module 204 can create graphical visualizations of the results obtained from analysis module 203. Graphical visualizations can include heat maps indicating which departments within a store yielded the most sales during a particular community event. Graphical visualizations can also depict which locations within a store sold the most products or were the most profitable during the community event. Graphical visualizations can also indicate store performance as it relates to number of employees working, and where the employees were predominately located. Graphical visualizations can be computer generated images, or an artist's rendering of store performance.

In some aspects, satellite imagery can be included as part of a graphical visualization. For example, satellite imagery can be a transparent overlay of satellite images over a graphical visualization. The satellite imagery can indicate the conditions of the store and its physical surroundings for a given graphical visualization. Satellite imagery used in an overlay can be linked back to extracted satellite imagery data. For example, satellite imagery used in an overlay can be the satellite imagery from which analyzed extracted satellite imagery data was extracted.

Communication module 205 can be a wired and/or wireless network adapter for connecting computer system 201 with network 251, such as, for example, a Wi-Fi and/or wired Ethernet network.

Display device 213 can be a general purpose display device, such as a monitor, a mobile device display, a TV, or a projector on a screen, used to portray graphical visualizations and satellite imagery. For example, display device 213 can be a projected image on a screen used to convey information to a group of personnel (e.g., a management team), where the information being displayed assists with formulating sales and service strategies. Display device 213 can also include a user interface which would allow the personnel to perform real-time data manipulation of the data sets received from computer system 201.

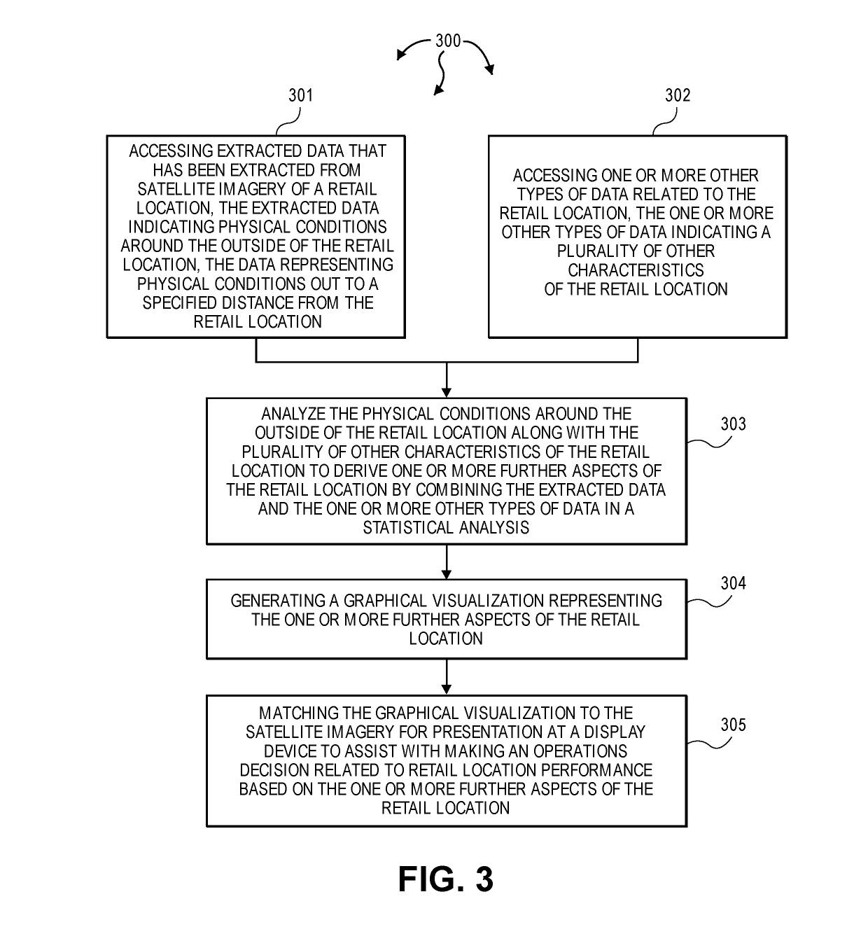

FIG. 3 illustrates a flow chart of an example method 300 for correlating data from satellite images with retail location performance. Method 300 will be described with respect to the components and data of computer architecture 200.

Method 300 includes accessing extracted data that has been extracted from satellite imagery of a retail location, the extracted data indicating physical conditions around the outside of the retail location, the data representing physical conditions out to a specified distance (301). For example, data access module 202 can access extracted satellite imagery data 227 from extracted satellite imagery database 221. Extracted satellite imagery data 227 can indicate physical conditions around the outside of a retail location (e.g., a store, shopping club, etc.). Extracted satellite imagery data 227 can represent physical conditions out to some specified distance from the retail location, such as, for example, a mile radius around the retail location. However, other types and lengths of distances can also be used. For example, a distance can correspond to a particular intersection or on a street adjacent to the retail location. The distance need not be symmetric and can extend to different distances in different directions from the retail location. In one aspect, the geometry of an area around a store location is configurable to any shape and can be constructed from selecting an area of interest from within a satellite image or other map.

Method 300 includes accessing one or more other types of data related to the retail location, the one or more types of data indicating a plurality of other characteristics of the retail location (302). For example, data access module 202 can access community events data 228 from community events database 222 and/or can access retail location performance data 229 from retail store performance database 223. Community events data 228 and retail location performance data 229 can indicate characteristics of the retail location under analysis.

Method 300 includes analyzing the physical conditions around the outside of the retail location along with the plurality of other characteristics of the retail store to derive one or more further aspects of the retail location by combining the extracted data and the one or more other types of data in a statistical analysis (303). For example, analysis module 203 can perform statistical analysis on extracted satellite imagery data 227 along with one or both of community events data 228 and retail location performance data 229. Analysis module 203 can derive one or more further aspects of the retail location under analysis by combining extracted satellite imagery data 227 with one or both of community events data 228 and retail location performance data 229 in one or more statistical analyses. Statistical analyses can include time lapse analysis, correlation analysis, cluster analysis, causal analysis, machine learning, etc. to determine if there are correlations between extracted satellite imagery data 227 and either of community events data 228 and retail location performance data 229 and determine the sensitivities of any correlations.

Method 300 includes generating a graphical visualization representing the one or more further aspects of the retail location (304). For example, visualization module 204 can create a graphical visualization 211 of the results obtained from analysis module 203.

Method 300 includes matching the graphical visualization to the satellite imagery for presentation at a display device to assist with making an operations decision related to retail store performance based on the one or more further aspects of the retail location (305). For example, visualization module can match graphical visualization 211 with satellite imagery 212 for presentation at display device 213. The combination of graphical visualization 211 and satellite imagery 212 can assist with making an operations decision related to performance of the retail location under analysis based on the one or more further aspects of the of the retail location under analysis. Satellite imagery 212 can correspond to extracted satellite imagery data 227. In one aspect, satellite imagery 212 is the satellite imagery from which extracted satellite imagery data 227 was extracted.

Satellite images can be analyzed for data as the satellite images are acquired. The satellite data can be accumulated and summarized at different levels of granularity (e.g., within extracted satellite imagery database 221). Internal data (e.g., holiday event data, associated data, costs, etc.) can also be extracted, accumulated, and summarized at different levels of granularity (e.g., in retail location performance database 223) to match the satellite data. External data (e.g., from weather centers, sports databases, community events databases, etc.) can also be extracted, accumulated, and summarized at different levels of granularity (e.g., in community events database 222) to match the satellite data.

Accumulated satellite data, internal data, and external data can be matched up and mashed together for (e.g., big) data statistical analysis. Data statistical analysis can include correlation analysis, cluster analysis, causal analysis, machine learning, etc. Visualizations can then be generated from the data statistical analysis. Visualizations can be matched up with satellite images for presentation to decision makers.

Accordingly, aspects of the invention facilitate extraction and conversion of two dimensional satellite images to create data for statistical analysis. Data from satellite image analysis can be mashed with other types of data for purposes of perspective analysis.

The foregoing description has been presented for the purposes of illustration and description. It is not intended to be exhaustive or to limit the invention to the precise form disclosed. Many modifications and variations are possible in light of the above teaching. Further, it should be noted that any or all of the aforementioned alternate embodiments may be used in any combination desired to form additional hybrid embodiments of the invention.

Further, although specific embodiments of the invention have been described and illustrated, the invention is not to be limited to the specific forms or arrangements of parts so described and illustrated. The scope of the invention is to be defined by the claims appended hereto, any future claims submitted here and in different applications, and their equivalents.

What is claimed:

1. A method for use at a computer system, the computer system including one or more processors and system memory, the method for correlating data from satellite images with retail location performance, the method comprising:
accessing extracted data that has been extracted from satellite imagery of a retail location, the extracted data indicating physical conditions around the outside of the retail location, the data representing physical conditions out to a specified distance from the retailer store;
accessing one or more other types of data related to the retail location, the one or more other types of data indicating a plurality of other characteristics of the retail location;
analyzing the physical conditions around the outside of the retail location along with the plurality of other characteristics of the retail location to derive one or more further aspects of the retail location by combining the extracted data and the one or more other types of data in a statistical analysis;
generating a graphical visualization representing the one or more further aspects of the retail location; and
matching the graphical visualization to the satellite imagery for presentation at a display device to assist with making an operations decision related to retail location performance based on the one or more further aspects of the retail location.

2. The method of claim 1, wherein the satellite imagery data includes an indication of the available parking lot area for the retail location.

3. The method of claim 1, wherein the satellite imagery data includes an indication of the percentage of parking lot area being used.

4. The method of claim 1, wherein the satellite imagery data includes traffic congestion on the streets near the location of the retail location.

5. The method of claim 1, wherein the satellite imagery data includes the traffic congestion at the street entrance(s) to the retail location.

6. The method of claim 1, wherein the satellite imagery data includes traffic congestion on the streets near a competing retail location.

7. The method of claim 6, wherein the satellite imagery data includes the traffic congestion at the street entrance(s) to the competing retail location.

8. The method of claim 1, wherein the satellite imagery data is time-lapsed data.

9. The method of claim 1, wherein retail location performance is defined by point-of-sale (POS) activity at the retail location.

10. The method of claim 1, wherein retail location performance is defined by point-of-sale (POS) activity.

11. The method of claim 1, wherein the one or more other types of data related to community events, the community events indicating an activity occurring in the community of the retail location, the community events including one or more of: sporting events, holiday events, entertainment events, weather events, or natural disaster events.

12. The method of claim 1, wherein the statistical analysis correlates the physical condition of the retail location with the retail location performance.

13. The method of claim 12, wherein the statistical analysis correlates the one or more other types of data with the retail location performance.

14. A system for correlating data from satellite images with retail location performance, the system comprising:
one or more processors;
system memory; and
one or more computer storage media having stored thereon computer-executable instructions that, when executed, cause the computer system to:
access extracted data that has been extracted from satellite imagery of a retail location, the extracted data indicating physical conditions around the outside of the retail location, the data representing physical conditions out to a specified distance from the retailer location;
access one or more other types of data related to the retail location, the one or more other types of data indicating a plurality of other characteristics of the retail location;
analyze the physical conditions around the outside of the retail location along with the plurality of other characteristics of the retail location to derive one or more further aspects of the retail location by combining the extracted data and the one or more other types of data in a statistical analysis;
generate a graphical visualization representing the one or more further aspects of the retail location; and
match the graphical visualization to the satellite imagery for presentation at a display device to assist with making an operations decision related to retail location performance based on the one or more further aspects of the retail location.

15. The system of claim 14, wherein computer-executable instructions that, when executed, cause the computer system to access one or more other types of data related to the retail location comprise computer-executable instructions that, when executed, cause the computer system to access community event data.

16. The system of claim 14, wherein computer-executable instructions that, when executed, cause the computer system to access one or more other types of data related to the retail location comprise computer-executable instructions that, when executed, cause the computer system to access retail location performance data.

17. The system of claim 14, wherein computer-executable instructions that, when executed, cause the computer system to analyze the physical conditions around the outside of the retail location along with the plurality of other characteristics of the retail location comprise computer-executable instructions that, when executed, cause the computer system to analyze physical conditions around the outside of the retail location along with community event data and retail location performance data.

18. A computer program product for use at a computer system, the computer program product implementing a method for correlating data from satellite images with retail location performance, the computer program product comprising one or more computer storage devices having stored thereon computer-executable instructions that, when executed at a processor, cause the computer system to perform the method, including the following:
access extracted data that has been extracted from satellite imagery of a retail location, the extracted data indicating physical conditions around the outside of the retail location, the data representing physical conditions out to a specified distance from the retailer store;
access one or more other types of data related to the retail location, the one or more other types of data indicating a plurality of other characteristics of the retail location;
analyze the physical conditions around the outside of the retail location along with the plurality of other characteristics of the retail location to derive one or more further aspects of the retail location by combining the extracted data and the one or more other types of data in a statistical analysis;
generate a graphical visualization representing the one or more further aspects of the retail location; and
match the graphical visualization to the satellite imagery for presentation at a display device to assist with making an operations decision related to retail location performance based on the one or more further aspects of the retail location.

19. The computer program product of claim 18, wherein computer-executable instructions that, when executed, cause the computer system to access one or more other types of data related to the retail location comprise computer-executable instructions that, when executed, cause the computer system to access one or more of: community event data and retail location performance data.

20. The computer program product of claim 18, wherein computer-executable instructions that, when executed, cause the computer system to analyze the physical conditions around the outside of the retail location along with the plurality of other characteristics of the retail location comprise computer-executable instructions that, when executed, cause the computer system to analyze physical conditions around the outside of the retail location along with community event data and retail location performance data.
